(19) United States
(12) Patent Application Publication
(10) Pub. No.: US 2021/0347252 A1
(43) Pub. Date: Nov. 11, 2021

(54) A SUCTION SYSTEM FOR A LIQUID RESERVOIR AND RESERVOIR HAVING SUCH SYSTEM

(71) Applicant: M.E.RIN SRL, Rome (IT)

(72) Inventor: Andrea GIAMBARTOLOMEI, Rome (IT)

(21) Appl. No.: 17/286,696

(22) PCT Filed: Oct. 17, 2019
(86) PCT No.: PCT/IB2019/058850

§ 371 Date: Apr. 19, 2021

(30) Foreign Application Priority Data
Oct. 17, 2018 (IT) 102018000009552

(51) Int. Cl. B60K 15/06; F02M 37/00

(52) U.S. Cl. CPC B60K 15/06; B60K 2015/03105; F02M 37/0088; F02M 37/0082

(57) ABSTRACT

suction system for a liquid reservoir (3) it is provided, the reservoir being defined by side walls and a bottom wall (30), the system comprising one layer of permeable material (2), and the system it is characterized in that it comprises fastening means (21) for fixing said permeable layer (2) onto at least one wall (30) of said reservoir (3); suction means (1, 10, 16, 17) of said liquid arranged within said permeable layer (2); and connecting means (14, 41, 42) of said suction means (1, 10, 16, 17) to a suction duct for sucking said liquid; the arrangement being such that an internal volume (23) it is defined between said one layer of permeable material (2), said fastening means (21), and said at least one wall of said reservoir (30), wherein the liquid it is sucked into said internal volume (23) through said layer of permeable material (2) and through said suction means (1, 10, 16, 17).

The present invention relates to a suction system for liquid tanks and, more precisely, to a suction system for liquid reservoirs through which it is possible to suck up liquid up to small volumes of liquid remaining inside the reservoir that mounts such system.

The subject of the present invention is also the reservoir which integrally integrates the present system.

### STATE OF THE ART

In applications where liquid is supplied from a liquid reservoir or a tank, a typical drawback it is known due to the difficulty of sucking (drawing) all the liquid therein contained when small volumes of said liquid remain inside the tank. This makes it impossible to use such remaining volume of liquid even if it is available inside the tank. This problem it is particularly felt in some particular applications such as, for example, in fuel tanks for racing vehicles, or in fuel tanks for military aircraft and the like, and in all those applications where the liquid contained in the tank it is subject to inclinations and accelerations that involve displacement of large volumes of liquid inside the tank, creating an interruption to the supplying of the liquid at the intake port.

To date, some technical solutions have been proposed and that aim to limit this drawback.

Among the various typical solutions proposed there are highlighted the following:
Pumps with filters arranged inside the tank;
Baskets containing the pump and which are filled by the Venturi effect;
Vertical containers containing low pressure pumps located at the corners of the base of a tank.

Examples of these types of constructive solutions are described in US523600 and US2011/002798.

Alternatively, another technical solution to this drawback has been proposed in document JP2012036792, which describes a fuel supply system from inside a fuel tank to the fuel pump. According to this document the supplying system aims to solve the problem of reliably sending the fuel to the outside of the tank even when the fuel it is running out and also when the fuel tank it is in an inclined condition. To do this, a secondary tank it is arranged inside the fuel tank, the secondary tank comprises a fuel filter and a fuel storage device arranged above the fuel filter. In the storage device a series of partitions or bulkheads there are provided which allow that when the surface of the fuel level it is inclined, the fuel remains “trapped” inside the bulkheads, thus ensuring a continuous supplying to the pump.

This constructive solution has the disadvantage of providing a system that it is complex and that does not suit the different configurations/shapes of existing tanks, and with considerable bulk and the relevant weight due to the assembly of the devices that make up the system.

Moreover, with the aim of solving the aforementioned drawback, the document WO2016073978A1 describes a fuel suction system inside a tank and the related tank that houses such a system, which system it is characterized by having a structure consisting of a small tank to be inserted and placed inside and on the bottom wall of the main tank, and the small tank being connected with the supplying of the fuel pump. The small tank it is made up of a flexible bladder-type structure and whose walls are made of a specific permeability material, and inside the small tank there is a material that yields to a specific rigidity. The function of the yielding material is to prevent the small tank from collapsing during the fuel intake and in the event that the fuel level drops below the volume of the small tank.

The constructive solution just described although it is sufficiently compact shows the drawback of consisting of a complex structure which comprises several layers of different materials for the making thereof. Moreover, there is the drawback given by the fact of having first to produce the structure illustrated above with a bladder, and second having to position the above structure within the main tank by inserting it inside the main tank.

The present invention aims to solve all the aforesaid drawbacks of the prior art by providing a suction system for liquid tanks through which it is possible to suck the liquid up to very small volumes of liquid inside said tank, and wherein said suction system has an extremely simplified structure which is integrated in the tank where it is mounted.

### BRIEF DESCRIPTION OF THE INVENTION

The present invention provides a suction system for a liquid tank which system comprises a single layer of permeable material, means for the fixing of said permeable layer on at least one wall of said tank, suction means for sucking said liquid arranged in said permeable layer, and means for connecting said suction means to a suction duct for sucking said liquid, the arrangement being such that an internal volume it is defined between said single layer of permeable material and said at least one wall of said tank, wherein the liquid it is sucked into said internal volume through the permeable material and through said suction means.

The present invention also provides a liquid reservoir which incorporates such a suction system.

Therefore, the present invention provides a suction system and a liquid reservoir substantially according to the annexed claims.

### DETAILED DESCRIPTION OF THE INVENTION

A detailed description will now be given of some preferred embodiments of the suction system of the present invention, given by way of non-limiting example and with reference to the appended figures, wherein:

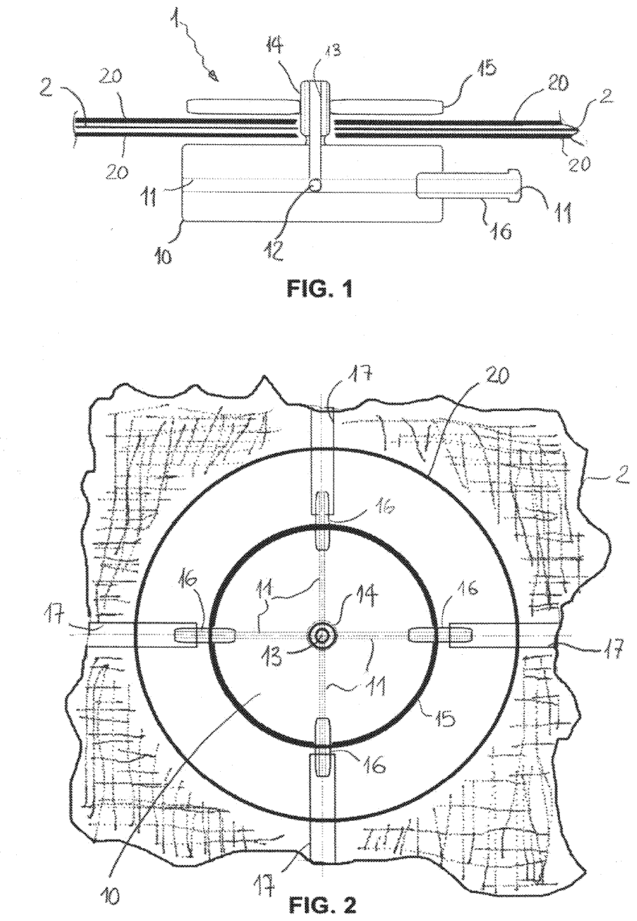

FIG. 1 it is a partial elevational view of a component of the suction system of the present invention;

FIG. 2 it is a partial plan view from above of the component of FIG. 1 according to the present invention;

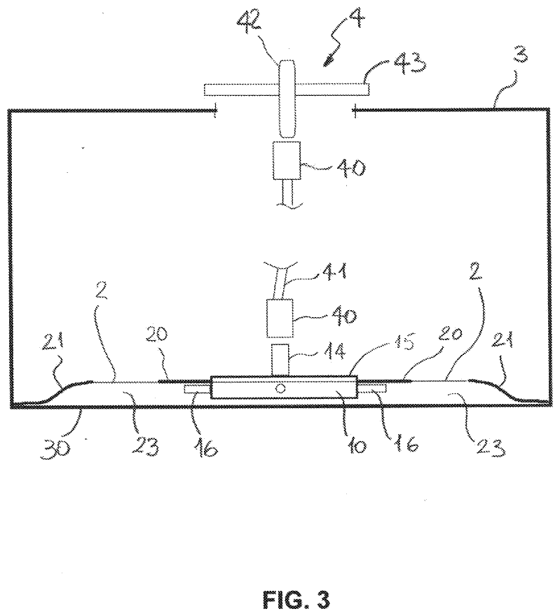

FIG. 3 it is a schematic elevational view and partially in section of the suction system arranged inside a tank according to a first embodiment of the present invention;

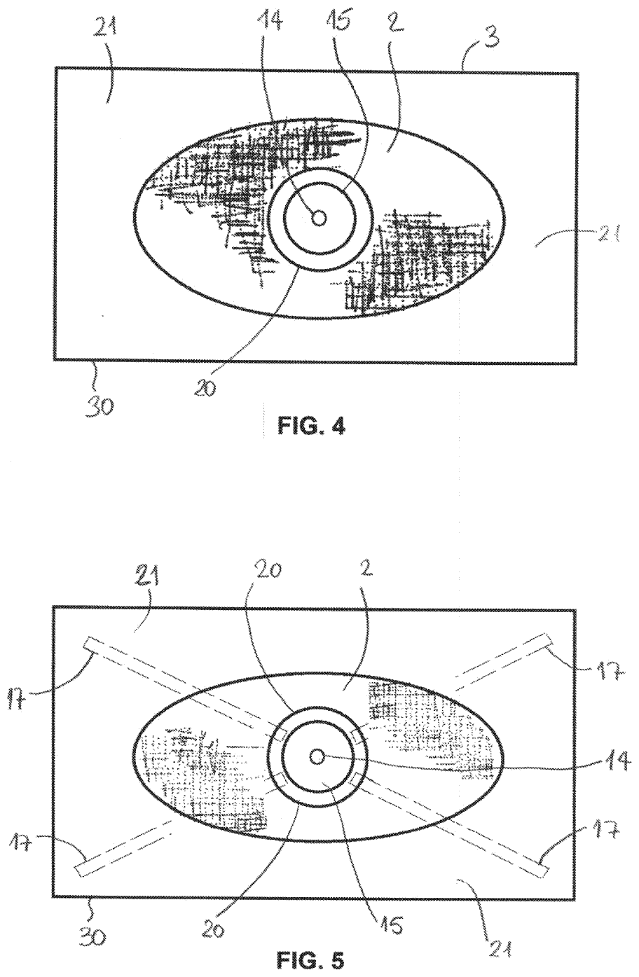

FIG. 4 it is a schematic plan view from above and partially in section of the suction system of FIG. 3 arranged inside a tank;

FIG. 5 it is a schematic plan view from above and partially in section of the suction system arranged inside a tank and according to a second embodiment of the present invention;

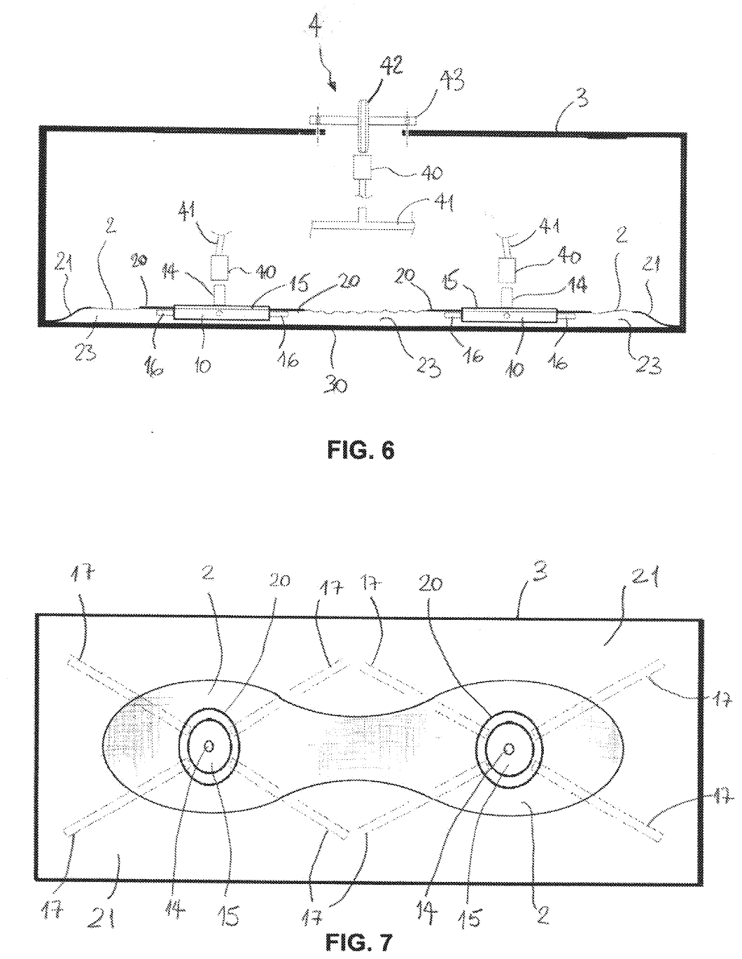

FIG. 6 it is a schematic elevational view and partially in section of the suction system arranged inside a tank according to a third embodiment of the present invention;

FIG. 7 it is a schematic plan view from above and partially in section of the suction system of FIG. 6 arranged inside a tank; and

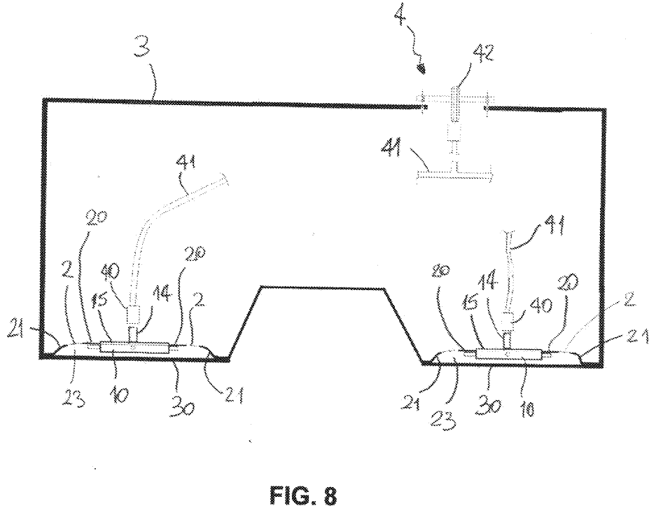

FIG. 8 it is a schematic elevational view and partly in section of the suction system arranged inside a tank according to a fourth embodiment of the present invention.

With reference now to FIGS. 1 and 2, a component of the suction system of the present invention it is illustrated therein.

According to the invention a suction valve 1 it is provided, and which comprises a main body 10 which according to the present embodiment has a circular cylindrical shape but can alternatively also be made in different forms.

The main body 10 has inside thereof a plurality of suction ducts 11 (and in the present embodiment four ducts 11 are shown) all communicating with a central port 12 communicating with a central suction duct 13. The central suction duct 13 has a threaded terminal 14 which engages with a disk-shaped locking element 15 by threading the same. Similarly, the suction ducts 11 can also have a terminal 16, each of which can engage with a respective flexible tube 17 in the manner already known, or by means of fixing means such as elastic bands or straps or the like (not shown in the figures).

According to the invention, a fabric 2 it is arranged between the valve body 10 and the disc shaped locking element 15, the fabric 2 having a predetermined established permeability to the liquid to be aspirated (permeability and surface tension established in the design phase according to the required performances).

For example and as a non-limiting purposes, the fabric 2 can be made of Nylon® monofilament with a 35×35 fabric weave (weft and warp) and Weight (gr/m2) of about 65 gr/m2.

Moreover, a gasket 20 it is provided between the fabric 2 and the disc-shaped locking element 15 and the valve body 10, consisting of a synthetic material suitable for the purpose such as, for example, the rubber to be vulcanized or the like (NBR compound). According to this arrangement and following to the vulcanization of the gasket 20, the assembly consisting of the valve body 10, the disk-shaped locking element 15, the gasket 20 and the fabric portion 2 (included between them) it is transformed in a single piece.

For the aforementioned purpose, it is provided that the body 10 and the disc-locking element 15 are surface treated with suitable adhesives and before vulcanization, so that following to the vulcanization of the rubber of the gasket 20 the irreversible gluing of the gasket 20 it is generated onto the surface of the first, and thus obtaining the integrity and the immovability of the couplings between gasket 20 and fabric 2 and valve body 10 and disk-shaped locking element 15.

By way of a non-limiting example, for the surface treatment of the body 10 and of the disc shaped locking element 15 with adhesives, the application of an adhesive for rubber/metal (NBR/Aluminum compound) may be provided, such as the one commercially known as “Chemosil® 211” produced by LORD Co.

With reference now to FIGS. 3 and 4, the suction system arranged inside a tank 3 according to a first embodiment of the present invention it is illustrated therein.

As it is possible to see in the figures, the system provides that the valve 1 it is arranged at the bottom wall 30 of a tank 3. In this condition the fabric 2 extends on the bottom wall 30 and at its perimetric edges has fixing means 21 for fixing the former to said bottom wall 30, the fixing means being both of the removable or alternatively fixed type.

More specifically, in the case in which the fixing means 21 are chosen of the fixed type, they can be constituted by a gasket 21 distributed on the peripheral edges of the fabric and fixed to the perimetral edges of the wall 30, the gasket 21 can preferably be constituted by a synthetic material suitable for the purpose such as, for example, the NBR compound of vulcanized rubber or similar.

Alternatively, in the case wherein the fixing means 21 are chosen of the removable type, they can be constituted by a waterproof zip type 21 (for the purpose of guaranteeing the waterproof to the liquid) which it is positioned at the peripheral edges of the fabric 2 and fixed at the perimeter edges of the wall 30.

In this way a volume 23 it is defined between the bottom wall 30, the fixing means 21, and the fabric 2, the volume 23 being contained inside the tank 3 and delimited by the edges of the bottom wall 30.

The threaded terminal 14 it is adapted to engage with a threaded connector 40 which puts in a pneumatic communication a flexible duct 41 to a suction terminal 42 arranged outside the tank 3 and mounted on a cover 43 in the manner already known. The intake terminal 42 is in turn connected to an intake duct of the suction pump (the latter is not shown in the figures).

It is important here to specify that, both for the arrangement and for the constitution of the fabric 2 (armour), the liquid contained inside the reservoir 3 can be transferred inside the volume 23 not only by gravity but also because it is sucked. In fact, once the liquid wets the surface of the fabric 2, the liquid can be transferred inside the volume 23 when suction it is started through the valve body 10. In fact, in this condition a depression it is created inside the volume 23 thanks to the tightness of the fabric 2 due to the contact surface tension between liquid and fabric 2.

With reference now to FIG. 5, the suction system arranged inside a tank 3 and according to a second embodiment of the present invention it is schematically illustrated.

For the sake of clarity, same parts will have same numbers and the detailed description thereof will be omitted here since already provided previously.

This second embodiment differs from the first embodiment in that within the volume 23 defined between fabric 2, fixing means 21, and bottom wall 30 and on each terminal 16 of the valve body 10 there are connected respective flexible suction tubes 17 (illustrated with dashed lines) arranged in a diagonal pattern directed at the corners of the tank 3.

With reference now to FIGS. 6 and 7, the suction system arranged inside a tank 3 according to a third embodiment of the present invention it is schematically illustrated.

For the sake of clarity, same parts will have same numbers and the detailed description thereof will be omitted here as already provided previously.

This third embodiment it is particularly directed to a large tank 3 or at least to a tank which has a prevailing dimension with respect to the other two dimensions.

According to this third embodiment it is provided that inside the volume 23 defined between fabric 2, fixing means 21, and bottom wall 30 two valves 1 are arranged in a substantially equidistant position one with respect to the other and to the walls of the reservoir 3. According to this embodiment can be provided on each terminal 16 of the valve body 10 respective suction flexible tubes 17 (illustrated with dashed lines) arranged according to a diagonal pattern directed at the corners of the tank 3.

Moreover, each valve 1 it is connected to a respective flexible pipe 41 through its own threaded terminal 14 and respective threaded connection 40, the flexible pipe 41 being connected by means of a “T” connector and pneumatically connects the valves 1 to a suction terminal 42 arranged outside the tank 3 and mounted on a cover 43 in the manner already known. The intake terminal 42 is in turn connected to an intake duct of the suction pump (the latter being not shown in the figures).

With reference now to FIG. 8, the suction system arranged inside a tank 3 according to a fourth embodiment of the present invention it is schematically illustrated therein.

For the sake of clarity, same parts will have same numbers and the detailed description thereof will be omitted here as already provided previously.

This fourth embodiment is particularly directed to a tank 3 which has non-symmetrical shapes or in any case a non-flat bottom wall 30 with a prevalent dimension with respect to the other two dimensions.

As can be seen in the figure, the tank 3 has a non-flat bottom wall 30. Therefore, according to the invention it is provided that on each deeper part of the bottom wall 30 there is arranged a respective valve 1 connected to a relevant fabric 2 and fixing means 21 at the perimetric edges of the bottom wall 30 in the configuration shown in previously.

As per the preceding embodiments, this arrangement also provides within the volume 23 defined between fabric 2 and bottom wall 30 a respective valve 1 in a position substantially equidistant from the walls of the tank 3. According to this fourth embodiment, it can be provided on each terminal 16 of the valve body 10 respective suction hoses 17 (not shown in the figure) arranged according to a diagonal pattern directed at the corners of the bottom wall 30.

Moreover, each valve 1 it is connected to a respective flexible pipe 41 through its own threaded terminal 14 and respective threaded connection 40, the flexible pipe 41 is connected by means of a “T” connector and pneumatically connects the valves 1 to a terminal suction 42 arranged outside the reservoir 3. The suction terminal 42 is in turn connected to a suction duct of the suction pump (the latter is not shown in the figures).

For the operation of the system, it is provided that within the volume 23 defined between fabric 2, fixing means 21, and bottom wall 30 the liquid of the tank 3 be contained thanks to the defined permeability of the fabric 2 as previously illustrated. When the suction pump it is actuated (outside the tank 3) a depression/vacuum it is created in the suction duct 41, which depression reaches the terminals 16 of each valve 1 (or the terminals of the flexible tubes 17). In this condition a pressure differential it is created between the outer wall of the fabric 2 and the wall within the volume 23 defined between the fabric 2 and the bottom wall 30. The pressure differential allows the fluid to penetrate continuously into the volume 23 from the outside of the fabric 2 (internal volume of the tank 3) and the bottom wall 30 and therein being sucked up by the terminals 16 towards the suction duct 41.

It will be apparent to those skilled in the art that the different embodiments illustrated of the suction system of the present invention allow the suction of liquid even for very small volumes of liquid remaining inside the tank 3.

Moreover, depending on different embodiments beyond those illustrated here, the permeable layer 2 can be connected by means of the fixing means 21 so that it also extends to additional surfaces beyond that of the bottom wall 30, for example also to portions of the side walls of the tank 3.

The suction system of the present invention has a number of advantages.

A first advantage lies in the fact that no small additional tank it is required inside the main tank (catch tank).

A second advantage lies in the fact that low-pressure pumps are not necessary to obtain suction even of very small volumes of liquid in the tank 3.

A third advantage lies in the fact that the internal pipes and the relevant electric circuit inside the tank are not necessary.

A fourth advantage resides in the fact that the draft of the liquid it is guaranteed in every condition of the tank 3 even if forced to inclination and/or strong acceleration.

A fifth advantage lies in the fact of providing extreme simplification for the mounting of the system inside the tank 3.

A sixth advantage lies in the considerable reduction in the weight of the whole assembly since the tank 3 contains only the valve(s) 1 inside it.

A seventh advantage lies in the lowering of the total cost of the tank 3 given by the simplification of the suction system thereof mounted inside the tank 3.

1. A suction system for a liquid reservoir the reservoir being defined by side walls and a bottom wall, the system comprising at least one layer of permeable material,
characterized in that it further comprises:
fixing means for fixing said permeable layer on at least one wall of said tank;
suction means of said liquid arranged within said permeable layer; and
connecting means of said suction means to a suction duct for said liquid;
the arrangement being such that an internal volume is defined between said one layer of permeable material, said fixing means, and said at least one wall of said tank, wherein the liquid is sucked into said internal volume and through said layer of permeable material and through the suction means.

2. Suction system for a liquid reservoir according to claim 1, wherein said at least one wall of said reservoir comprises the bottom wall of said reservoir.

3. Suction system for a liquid reservoir according to claim 1, wherein said fixing means of said permeable layer on at least one wall of said reservoir are not removable.

4. Suction system for a liquid reservoir according to claim 3, wherein said fixing means comprises a gasket mounted at the perimetric edges of said permeable layer and fixed on the perimetric edges of said wall, said gasket being made of a synthetic material such as NBR mixture of vulcanized rubber or the like.

5. Suction system for a liquid reservoir according to claim 1, wherein said fixing means are removable.

6. Suction system for a liquid reservoir according claim 5, wherein said fixing means are constituted by a waterproof sealed zip which it is positioned at the perimeter edges of the permeable material and fixed on the perimeter edges of said wall.

7. Suction system for a liquid reservoir according to claim 1, wherein said suction means comprises an intake valve mounted at said bottom wall of said reservoir and inserted in said internal volume and connected with said permeable layer.

8. Suction system for a liquid reservoir according claim 7, wherein said valve comprises:
a main body having inside thereof a plurality of suction ducts communicating with a central suction duct which comprises a threaded terminal; and
a locking element for cooperating with said threaded terminal;
the arrangement being such that said layer of permeable fabric it is arranged between said valve body and said locking element.

9. Suction system for a liquid reservoir according to claim 8, wherein each of said suction ducts comprise a terminal which engages with a respective suction flexible tube.

10. Suction system for a liquid reservoir according to claim 8, wherein a gasket it is arranged between said permeable fabric, said locking element, and said valve body, said gasket consisting of a synthetic material.

11. Suction system for a liquid reservoir according to claim 10, wherein said gasket it is made of NBR compound, the arrangement being such that following the vulcanization of said gasket, the assembly consisting of said valve body, said locking element, said the gasket and said portion of permeable fabric are all mutually blocked therebetween.

12. Suction system for a liquid reservoir according to claim 8, wherein said body and said locking element are surface-treated by means of adhesives before the assembly of said permeable layer, the arrangement being such that, following the vulcanization of the gasket, it is generated an irreversible locking of the assembly consisting of gasket, permeable fabric, valve body, and locking element.

13. Suction system for a liquid reservoir according to claim 2, wherein said fixing means of said permeable layer on at least one wall of said reservoir are not removable.

14. Suction system for a liquid reservoir according to claim 2, wherein said fixing means are removable.

15. Suction system for a liquid reservoir according to claim 2, wherein said suction means comprises an intake valve mounted at said bottom wall of said reservoir and inserted in said internal volume and connected with said permeable layer.

16. Suction system for a liquid reservoir according to claim 3, wherein said suction means comprises an intake valve mounted at said bottom wall of said reservoir and inserted in said internal volume and connected with said permeable layer.

17. Suction system for a liquid reservoir according to claim 4, wherein said suction means comprises an intake valve mounted at said bottom wall of said reservoir and inserted in said internal volume and connected with said permeable layer.

18. Suction system for a liquid reservoir according to claim 5, wherein said suction means comprises an intake valve mounted at said bottom wall of said reservoir and inserted in said internal volume and connected with said permeable layer.

19. Suction system for a liquid reservoir according to claim 6, wherein said suction means comprises an intake valve mounted at said bottom wall of said reservoir and inserted in said internal volume and connected with said permeable layer.

20. Suction system for a liquid reservoir according to claim 9, wherein a gasket it is arranged between said permeable fabric, said locking element, and said valve body, said gasket consisting of a synthetic material.
